(19) United States
(12) Patent Application Publication
(10) Pub. No.: US 2006/0146063 A1
(43) Pub. Date: Jul. 6, 2006

(54) Method for creating normal map data

(76) Inventor: Akio Ohba, Kanagawa (JP)

Correspondence Address: KATTEN MUCHIN ROSENMAN LLP, 575 MADISON AVENUE, NEW YORK, NY, 10022-2585, US

(21) Appl. No.: 11/296,693

(22) Filed: Dec. 7, 2005

(30) Foreign Application Priority Data
Dec. 8, 2004 (JP) 2004-355837

(51) Int. Cl. G09G 5/00

(52) U.S. Cl. 345/584

(57) ABSTRACT

A bump mapping technique for performing graphic processing at high speeds is provided. The initial normal bump map data described by normal vectors is acquired, and then integrated to be temporarily converted into the initial height bump map data that is described in the form of height data. The transformed height data is created which describes the contents of a transformation in the form of height data, and the transformed height data is combined with the initial height bump map data to create the modified height bump map data. The modified height bump map data is partially differentiated to be thereby converted into the modified normal bump map data that is described by normal vectors, and the modified normal bump map data is stored.

### BACKGROUND OF THE INVENTION

1. Field of the Invention

The present invention relates to a graphic processing technology in computer graphics, and more particularly to a bump mapping technique for representing the roughness of an object.

2. Description of the Related Art

In general, the three-dimensional (3D) computer graphic technique utilizes a polygon model to represent an object in three-dimensional space using a number of polygons. In graphic processing of a polygon model, shading is performed such that a light source, the location of a view point, and the surface light reflectivity of an object are taken into account to shade the surface of a polygon.

To easily make the surface of an object appear to be bumpy, available is a technique called “bump mapping” to which an idea of texture mapping is applied. In bump mapping, normal vectors are mapped to the surface of an object to create pseudo-normal vectors on the surface of the object. Assuming that the resulting pseudo-normal vector is in the direction of the normal to the surface of the object, shading processing is performed so that the brightness values of the surface are determined for shading. This allows for making the object surface appear to be bumpy in a pseudo manner.

In Japanese Patent Laid-Open Publication No. 2002-203255, the applicant suggested a bump mapping technique in which a color lookup table used for color conversion in texture mapping was employed as a lookup table for normal vectors.

The bump mapping makes it possible to easily make the surface of an object appear to be bumpy without detailed modeling of the object surface. However, the bump mapping requires mapping of a normal vector to the surface of the object on a per-pixel basis and brightness calculations for all the normal vectors, thus demanding increased computation costs and elongated periods of time for processing. Additionally, the values of the normal vectors are stored on a per-pixel basis, thus requiring an increased amount of memory. In this context, the bump mapping technique, which uses a color lookup table as suggested in Japanese Patent Laid-Open Publication No. 2002-203255, is adapted to quantize the normal vectors into a reduced number of reference normal vectors. It is thus possible to reduce the calculation cost and the amount of memory. The quantization of normal vectors successfully solved the problems with the aspects concerning processing speeds and memory capacity.

Now, suppose that a transformation is applied to an object, whose roughness is represented by bump mapping using such normal vectors, to draw the transformed object. For example, it is assumed that a transformation is carried out such that new roughness is added to a bump mapped sphere having normal vectors pre-mapped thereto. The transformed sphere to which such new roughness has been added by the conventional bump mapping technique is to be drawn as follows. That is, polygons having the new roughness added to an original sphere are created. Then, the polygons are subjected to the bump mapping again such that normal data described by the normal vectors is mapped to the surface of the polygons, and then shading is followed. However, such processing would require an increased amount of calculations for the drawing. In particular, the 3D computer graphics in which information to be drawn in response to user instructions varies every moment, as typified by games, require real-time drawing of objects. Accordingly, it is a critical issue to improve the speed of graphic processing.

### SUMMARY OF THE INVENTION

The present invention was devised in view of the aforementioned problems. It is therefore an object of the present invention to provide a bump mapping technique which enables high-speed graphic processing.

To solve the above problems, one aspect of the present invention is a method for creating normal map data. The method includes firstly converting normal map data described by a normal vector into height map data described in the form of height data. Then, the method includes combining transformed height data describing contents of a transformation in the form of height data with the height map data thus obtained, to create modified height map data. Then, the method includes converting the modified height map data into modified normal map data described by a normal vector, and storing the modified normal map data.

According to this aspect, the shape of polygons constituting an object is not changed but a transformation is applied to the normal map data to represent the roughness of the transformed object using the normal map data, thereby allowing graphic processing to be performed at high speeds.

Furthermore, the normal map data described by a normal vector is converted into the form of height data to apply a transformation to the height data, and thereafter converted into normal map data. Accordingly, when a transformation is carried out using a height as a parameter, it is possible to use height data.

the combining may be performed such that the height data describing the height map data obtained by conversion is directly modified corresponding to the contents of a transformation, thereby creating modified height map data.

Another aspect of the present invention is also a method for creating normal map data. The method includes converting transformed height data describing contents of a transformation in the form of height data into transformed normal data described by a normal vector. Then, the method includes combining the transformed normal data with normal map data described by a normal vector to create modified normal map data, and storing the modified normal map data.

In this aspect, the shape of polygons constituting an object is not changed but a transformation is to be applied to the normal map data to represent the roughness of the transformed object using the normal map data, thereby allowing graphic processing to be performed at high speeds.

It is to be noted that any arbitrary combination or rearrangement of the above-described structural components and so forth are all effective as and encompassed by the present embodiments.

Moreover, this summary of the invention does not necessarily describe all necessary features so that the invention may also be sub-combination of these described features.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIGS. 1A and 1B are views illustrating the contents of image processing which can preferably utilize a method for creating bump map data according to an embodiment;

FIGS. 2A to 2C are views illustrating part of an object shown in FIG. 1A;

FIG. 3 is a flowchart showing a method for creating bump map data according to a first embodiment;

FIG. 4 is a view schematically illustrating the method for creating bump map data according to the first embodiment;

FIGS. 5A to 5C are views illustrating bump map data mapped to an untransformed object;

FIGS. 6A and 6B are views schematically illustrating the conversion of normal data to height data;

FIG. 7 is a table showing the relationship between the quantized reference normal vector, the index, and the brightness value;

FIG. 8 is a flowchart showing a method for creating bump map data according to a second embodiment;

FIG. 9 is a view illustrating the configuration of a graphic processing apparatus according to the second embodiment;

FIG. 10 is a flowchart showing a method for creating bump map data according to a third embodiment;

FIG. 11 is a view schematically illustrating the method for creating bump map data according to the third embodiment;

FIG. 12 is a flowchart showing a method for creating bump map data according to a fourth embodiment; and

FIG. 13 is a view illustrating the configuration of a modified bump map data generation unit for implementing a graphic processing method according to the fourth embodiment.

### DETAILED DESCRIPTION OF THE INVENTION

The invention will now be described based on preferred embodiments which do not intend to limit the scope of the present invention but exemplify the invention. All of the features and the combinations thereof described in the embodiment are not necessarily essential to the invention.

First, the present invention will be outlined and then detailed with reference to the embodiments.

A method for creating normal map data according to one aspect of the present invention includes: firstly converting normal map data described by a normal vector into height map data described in the form of height data; combining transformed height data describing contents of a transformation in the form of height data with the height map data to create modified height map data; converting the modified height map data into modified normal map data described by a normal vector; and storing the modified normal map data.

According to this aspect, the normal map data described by a normal vector is converted into the form of height data to apply a transformation to the height data, and thereafter converted into normal map data. As a result, a transformation is to be applied not to the shape data of an original object but to the normal map data. Accordingly, it is possible to perform graphic processing at higher speeds when compared with a case where the shape of a polygon is transformed to perform bump mapping again. Furthermore, when a transformation is carried out using a height as a parameter, it is possible to use height data.

Another aspect of the present invention is also a method for creating normal map data. The method for creating normal map data includes: firstly converting normal map data described by a normal vector into height map data described in the form of height data; creating modified height map data by modifying the height data describing the height map data thus obtained, corresponding to contents of a transformation; converting the modified height map data into modified normal map data described by a normal vector, and storing the modified normal map data.

According to this aspect, a transformation is to be applied not to the shape data of an original object but to the normal map data. Accordingly, it is possible to perform graphic processing at higher speeds when compared with a case where the shape of a polygon is transformed to perform bump mapping again. Furthermore, when a transformation is carried out using a height as a parameter, it is possible to use height data.

The normal vector describing the normal map data used in the first conversion may be quantized, and the storing may be performed such that the normal vector describing the modified normal map data is also be quantized.

The normal vector describing the normal map data can be quantized, thereby reducing the amount of memory required.

Yet another aspect of the present invention is a graphic processing method. The method includes: previously calculating a brightness value for each quantized normal vector; and, when shading is performed based on the quantized modified normal map data created by the aforementioned method for creating normal map data, referring to a brightness value corresponding to the quantized normal vector describing the modified normal map data, and performing shading based on the referred brightness value.

According to this aspect, a brightness value is previously calculated for a quantized normal vector. When shading is performed after a transformation has been carried out, this eliminates the need for calculating brightness values for all normal vectors. It is thus made possible to reduce the amount of calculations and memory, thereby realizing graphic processing at high speeds.

Still another aspect of the present invention is also a method for creating normal map data. This method includes: converting transformed height data describing contents of a transformation in the form of height data into transformed normal data described by a normal vector; combining the transformed normal data with normal map data described by a normal vector to create modified normal map data, and storing the modified normal map data.

According to this aspect, the contents of a transformation represented by height data are to be converted into the form of normal data, allowing computations to be performed between normal vectors, thus causing the transformation to be directly applied to the normal map data. Accordingly, it is possible to perform graphic processing at higher speeds when compared with a case where the shape of a polygon is transformed to perform bump mapping again.

The combining may be performed such that the transformed normal data and the normal map data are weighted for addition.

Such weighting makes it possible to control which to be predominantly represented, either the shape associated with the contents of the transformation or the roughness represented by the normal map data.

The combining is performed such that, for a region having a distinctive shape indicated by the transformed height data, the transformed normal data obtained through a conversion of the transformed height data may be assigned a heavier weight.

The normal vector describing the normal map data may be quantized, and the storing may be performed such that the normal vector describing the modified normal map data is also quantized.

The normal vector describing the normal map data can be quantized, thereby reducing the amount of memory required.

Another aspect of the present invention is a graphic processing method. The method includes: previously calculating a brightness value for each quantized normal vector; and, when shading is performed based on the quantized modified normal map data created by the aforementioned method for creating normal map data, referring to a brightness value corresponding to the quantized normal vector describing the modified normal map data, and performing shading based on the referred brightness value.

According to this aspect, a brightness value is calculated for a quantized normal vector in advance. When shading is performed after a transformation has been carried out, this eliminates the need for calculating brightness values for all normal vectors. It is thus made possible to reduce the amount of calculations and memory, thereby realizing graphic processing at high speeds.

Still another aspect of the present invention is a graphic processing apparatus. The apparatus includes: a de-converting unit which converts normal map data described by a normal vector into height map data described in the form of height data once; a combining unit which combines transformed height data describing contents of a transformation in the form of height data with the height map data to create modified height map data; a converting unit which converts the modified height map data into modified normal map data described by a normal vector; and a memory which stores the modified normal map data.

According to this aspect, a transformation is to be applied not to the original shape data but directly to the normal map data. Accordingly, it is possible to perform graphic processing at high speeds. Furthermore, when a transformation is carried out using a height as a parameter, it is possible to use height data.

The combining unit which creates modified height map data may be replaced with a transforming unit which modifies the height data describing the height map data obtained in the de-converting unit corresponding to the contents of the transformation to create modified height map data.

Still another aspect of the present invention is also a graphic processing apparatus. The apparatus includes: a converting unit which converts transformed height data describing contents of a transformation in the form of height data into transformed normal data described by a normal vector; a combining unit which combines the transformed normal data with normal map data described by a normal vector to create modified normal map data, and a memory which stores the modified normal map data.

According to this aspect, the contents of a transformation represented by height data are converted into the form of normal data, allowing computations to be performed between normal vectors, thus applying the transformation directly to the normal map data. Accordingly, it is possible to perform graphic processing at high speeds.

Another aspect of the present invention is a program. This program makes a computer execute: firstly converting normal map data described by a normal vector into height map data described in the form of height data; combining transformed height data describing contents of a transformation in the form of height data with the height map data to create modified height map data; converting the modified height map data into modified normal map data described by a normal vector; and storing the modified normal map data.

Still another aspect of the present invention is also a program. The program makes a computer execute: firstly converting normal map data described by a normal vector into height map data described in the form of height data; modifying height data describing the height map data thus obtained, corresponding to contents of a transformation, to create modified height map data; converting the modified height map data into modified normal map data described by a normal vector; and storing the modified normal map data.

Still another aspect of the present invention is also a program. The program makes a computer execute: converting transformed height data describing contents of a transformation in the form of height data into transformed normal data described by a normal vector; combining the transformed normal data with normal map data described by a normal vector to create modified normal map data; and storing the modified normal map data.

It is to be understood that any combination of the aforementioned components or the components and representations of the present invention exchanged between methods, apparatuses, systems, or programs will be also valid as an aspect thereof.

Now, the aforementioned aspects of the present invention will be detailed below in accordance with the embodiments.

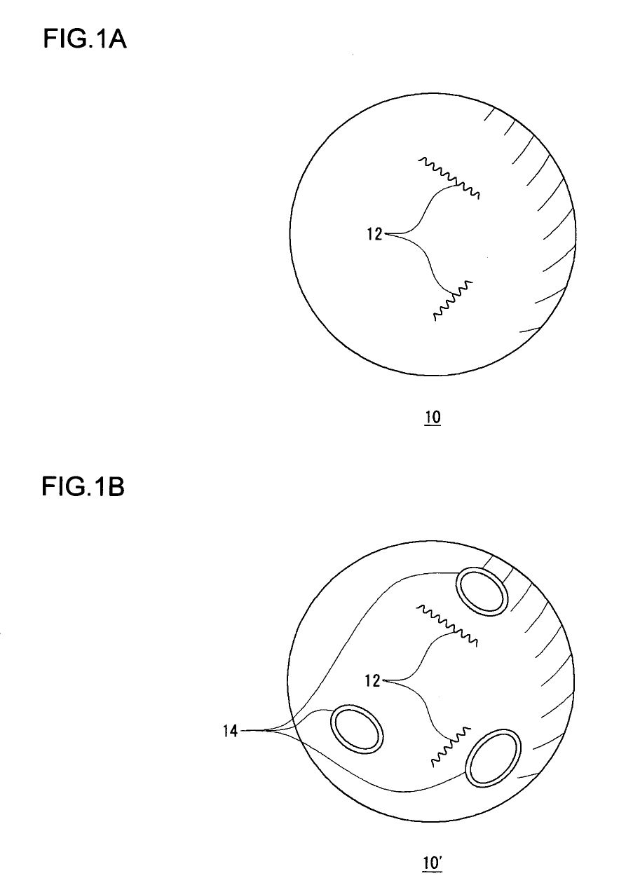

First, processing to be performed in each embodiment will be outlined below. FIGS. 1A and 1B show the contents of image processing which can preferably utilize a method for creating bump map data according to an embodiment. The description will be given to a case where the moon represented as a sphere having shallow roughness as shown in FIG. 1A is transformed to be provided with craters. An object 10 shown in FIG. 1A is a sphere to which normal map data described by normal vectors is pre-mapped to represent roughness 12. An object 10′ shown in FIG. 1B is the object 10 of FIG. 1A which has been transformed so that new roughness 14 corresponding to the craters are added thereto.

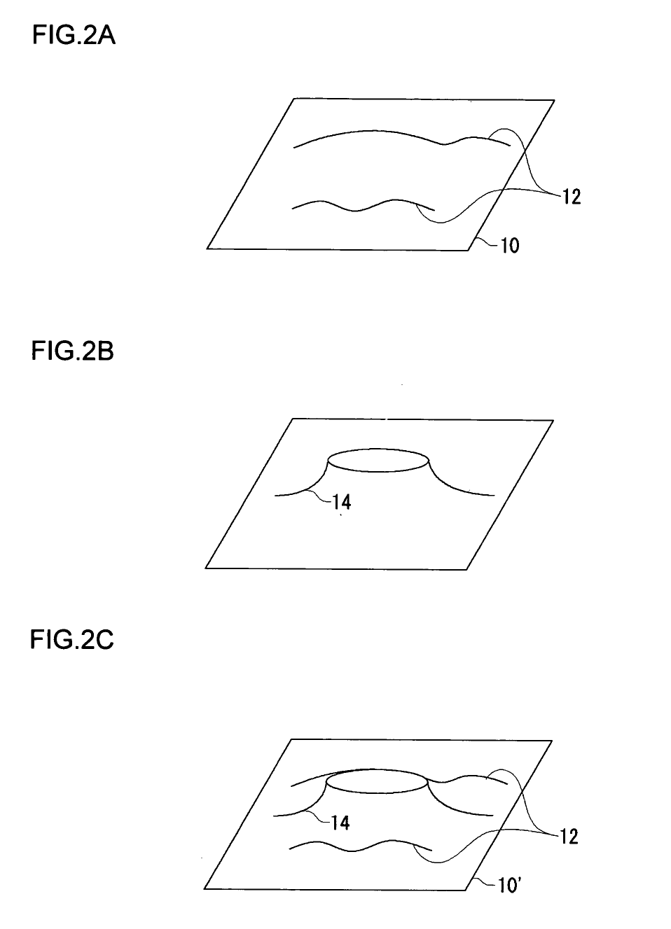

FIGS. 2A to 2C illustrate part of the object 10 shown in FIG. 1. FIG. 2A illustrates a portion of the object 10 shown in FIG. 1A. FIG. 2B illustrates the contents of a transformation introduced to the portion of the object 10 shown in FIG. 2A. FIG. 2C illustrates a portion of the transformed object 10′ shown in FIG. 1B.

As will be described below, a method for creating bump map data according to this embodiment can be preferably used for graphic processing such a transformed object 10′.

### FIRST EMBODIMENT

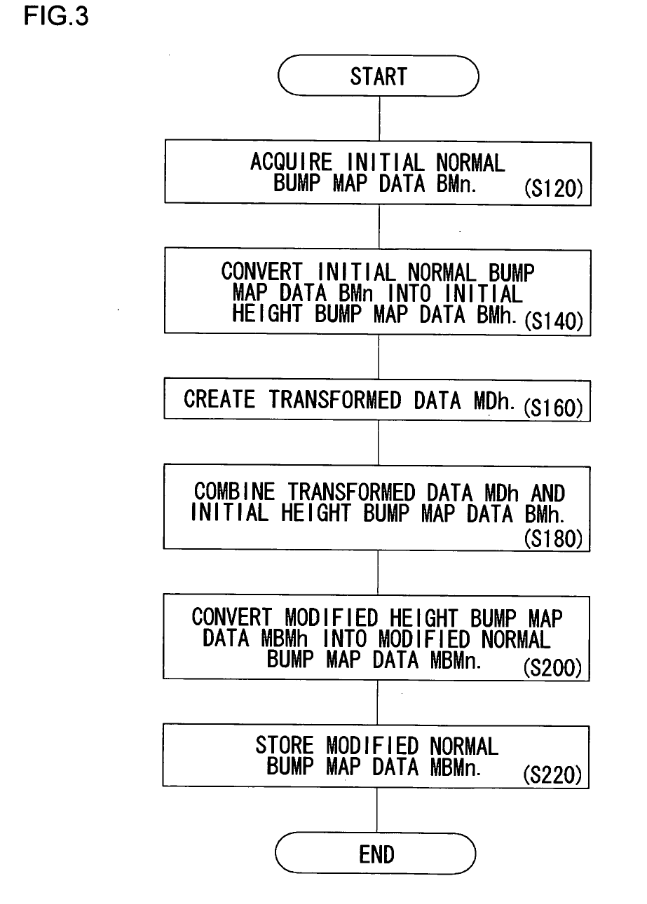

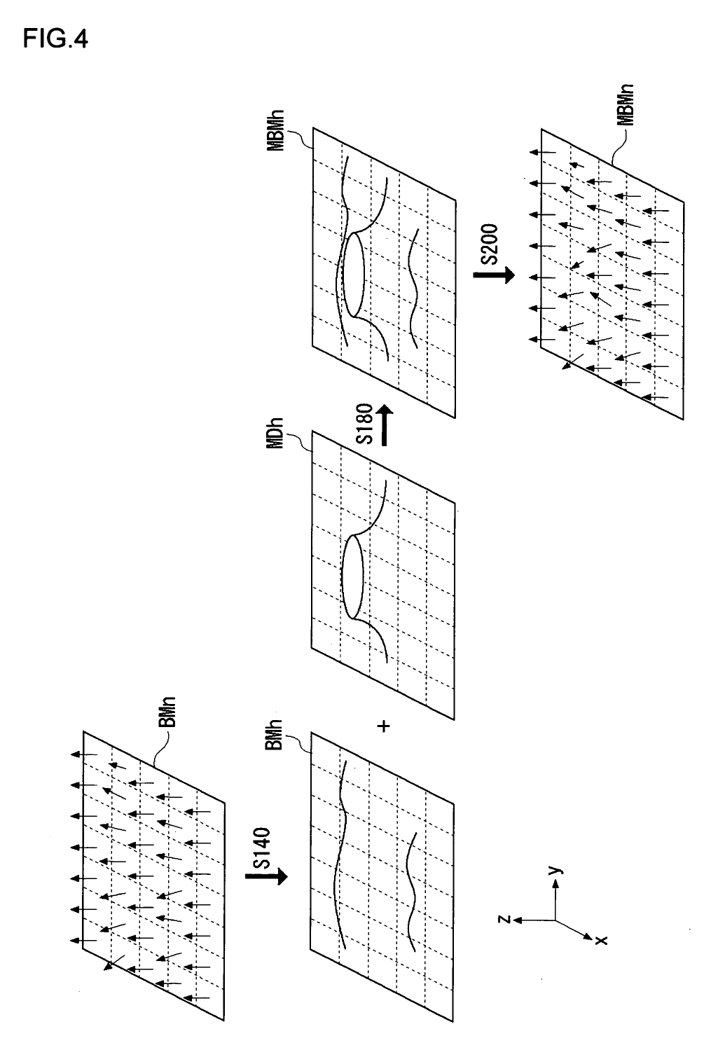

FIG. 3 shows a flowchart of a method for creating bump map data according to a first embodiment. FIG. 4 is a view schematically illustrating the method for creating bump map data according to the first embodiment. In FIGS. 3 and 4, the same reference symbols are given to the steps that are associated with each other.

Now, the method for creating bump map data according to the first embodiment is described with reference to the drawings.

The method for creating bump map data according to this embodiment acquires normal bump map data (hereinafter referred to as the “initial normal bump map data BMn) which is described by the normal vectors of the untransformed object 10 having the shallow roughness 12 shown in FIG. 2A (S120).

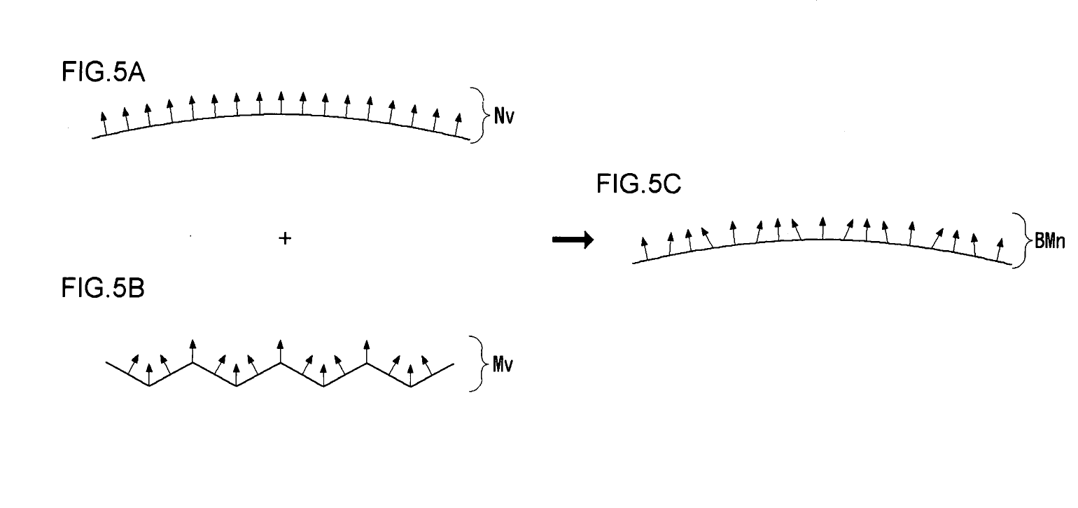

FIGS. 5A to 5C are views illustrating the bump map data that is mapped to the untransformed object 10. FIG. 5A illustrates normal vectors Nv of the object 10, and FIG. 5B shows bump map data Mv which is mapped to represent the roughness of the object 10. FIG. 5C illustrates pseudo normal bump map data BMn that is obtained by mapping the bump map data Mv to the object 10. In the 3D computer graphics, the bump mapping is used to represent roughness in a pseudo manner by changing only the normal direction without changing the surface shape of an object.

Referring now back to FIG. 3, the normal bump map data BMn acquired in the aforementioned processing S120 corresponds to the data shown in FIG. 5C. When the object 10 has been already drawn by shading using the normal bump map data BMn, the initial normal bump map data BMn can be read on the memory to be thereby acquired. On the other hand, when the object 10 has not yet been drawn, the normal vectors Nv of the object 10 and the bump map data Mv can be vectorially combined to calculate a sum, BMn=Mv+Nv to acquire the initial normal bump map data BMn.

Next, the initial normal bump map data BMn described by normal vectors is converted into the form of height data corresponding to the height from a reference plane (S140). The data converted to the form of height data is referred to as the initial height bump map data BMh.

When a height is given by z=H(x, y) and H(x, y) can be differentiated, normal data N(x, y) is given by N(x, y)=[−∂H/∂x, −∂H/∂y, 1]. In the equation above, ∂/∂x and ∂/∂y show a partial differentiation with respect to variables x and y, respectively. Accordingly, the initial normal bump map data BMn in the form of normal data can be spatially integrated and thereby converted into the initial height bump map data BMh in the form of height data.

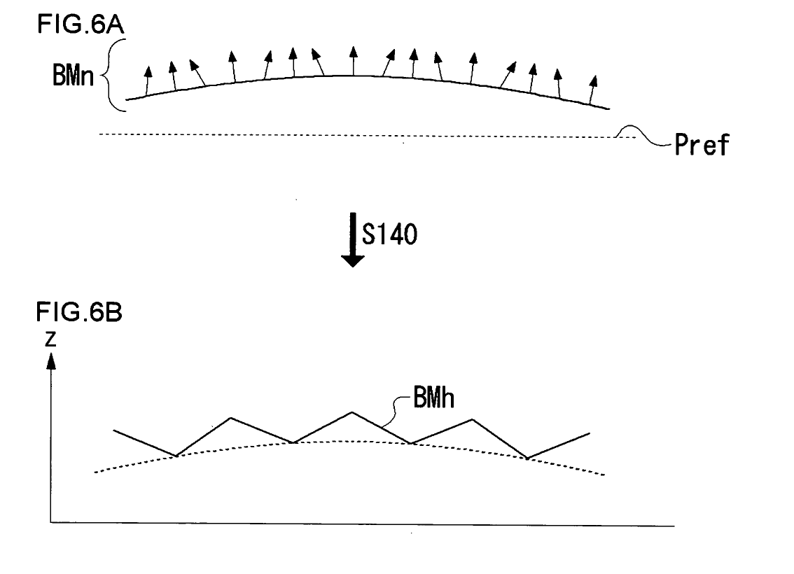

FIGS. 6A and 6B schematically illustrate the conversion of normal data to height data, FIG. 6A showing the normal data, FIG. 6B showing the height data. In FIGS. 6A and 6B, a reference plane Pref is indicated by a short dashed line. Since the differentiation to be described below is performed to obtain the bump map data of interest, the same bump map data can be created irrespective of where the reference plane selected is located.

Next, the process creates transformed data (hereinafter referred to as the transformed height data MDh) associated with the shape to be added to the object 10 shown in FIG. 2B (S160). The transformed height data MDh is described by height data.

It may be acceptable to transpose the processing performed in S160 and that in S120 or S140.

Next, as shown in FIG. 4, the process combines the transformed height data MDh and the aforementioned initial height bump map data BMh (S180). The data resulting from this combination represents the shape of the transformed object 10′ in the form of height data. The data representative of the shape of the transformed object is referred to as the modified height bump map data MBMh. It is possible to combine pieces of data described in the form of height data with each other by determining a scalar sum of the pieces of height data associated with respective coordinates (pixels).

In creating the modified height bump map data MBMh, the combination is not necessarily carried out after the transformed height data MDh has been created. The height data of the initial height bump map data BMh may be directly changed or modified, thereby creating the modified height bump map data MBMh corresponding to the new shape.

Next, the process converts the modified height bump map data MBMh in the form of height data into modified normal bump map data MBMn described by normal vectors (S200). As described above, this conversion can be carried out through a spatial partial differentiation of height data. The resulting modified normal bump map data MBMn represents the normal direction to the surface shape of the transformed object 10′.

The process stores the modified normal bump map data MBMn to shade the object 10′ (S220).

In shading and drawing the transformed object 10′, the modified normal bump map data MBMn can be used to calculate a brightness value α, thereby representing the roughness of the object 10′.

According to the method for creating bump map data in accordance with this embodiment, the object 10 is transformed such that the shape of the object 10 itself is not changed but the transformation is carried out in the region of the bump map data. This makes it possible to reduce the amount of calculations and carry out transformations at high speeds.

Furthermore, in performing the combining process corresponding to a transformation, heights can be used as a parameter of the transformation because the bump map data is described by height data.

For example, in transforming an untransformed object 10, the transformation can be carried out, using the initial height bump map data BMh as a parameter, in a manner such that in the original object 10, a larger transformation is applied to a portion at a higher altitude, whereas a smaller transformation is applied to a portion at a lower altitude.

### SECOND EMBODIMENT

In the second embodiment, a description will be given to an approach for using the method for creating bump map data according to the first embodiment to quantize normal vectors describing the bump map data, thereby realizing high-speed graphic processing and memory savings.

In this embodiment, bump map data is described using a plurality of pre-specified reference normal vectors. The quantization of normal vectors is performed such that a predetermined quantity of reference normal vectors are pre-specified as a representative vector for a given pseudo-normal vector that can be defined on the surface of a 3D object, and then the given pseudo-normal vector is approximated by one of the reference normal vectors that is closest thereto. At this stage, the quantity of the reference normal vectors is set to be less than the quantity of the pseudo-normal vectors created on the surface of the 3D object.

In this embodiment, such a case is described where eight bits are used to quantize the normal vector. When the normal vector is quantized using 8 bits, 256 reference normal vectors Vqn0 to Vqn255 are to be pre-specified. The relationship between the index ID and the quantized reference normal vector is stored in a VQ (Vector Quantization) table. In the graphic processing according to this embodiment, the bump map data is described indirectly by the index ID.

A combination of the reference normal vectors Vqn may include 256 normal vectors. In this case, for example, a spherical surface is divided into 256 planes and approximated by a 256-plane polyhedron, so that the 256 normal vectors indicate the perpendicular directions to the divided planes, respectively. Any combination of 256 reference normal vectors can be selected. For example, a different combination of 256 reference normal vectors can be obtained by differently shifting the phase of the polyhedron when the spherical surface is divided into 256 planes.

Additionally, for the respective reference normal vectors Vqn0 to Vqn255, the brightness value a is calculated corresponding to the current positions of the light source and the view point. The brightness value a associated with the index ID of the reference normal vector is stored in a color lookup table CLUT. Once calculated, the brightness value a needs not to be recalculated until a parameter such as the color or orientation of the light source or the location or orientation of the view point is changed.

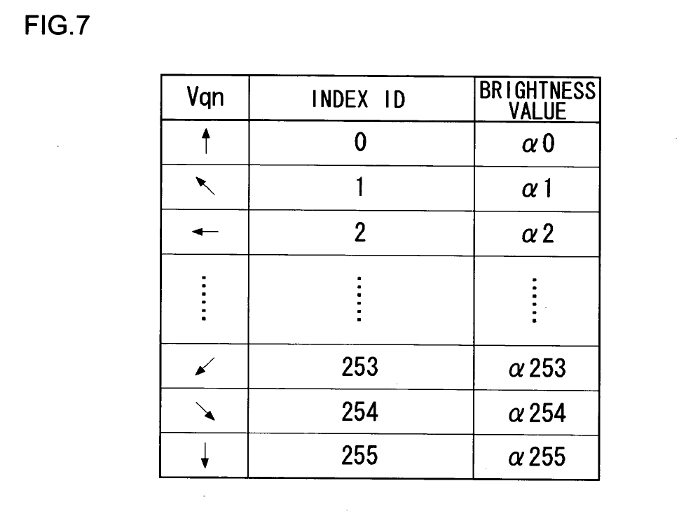

FIG. 7 shows the VQ table indicating the relationship between the quantized reference normal vector and the index ID, and the contents of CLUT.

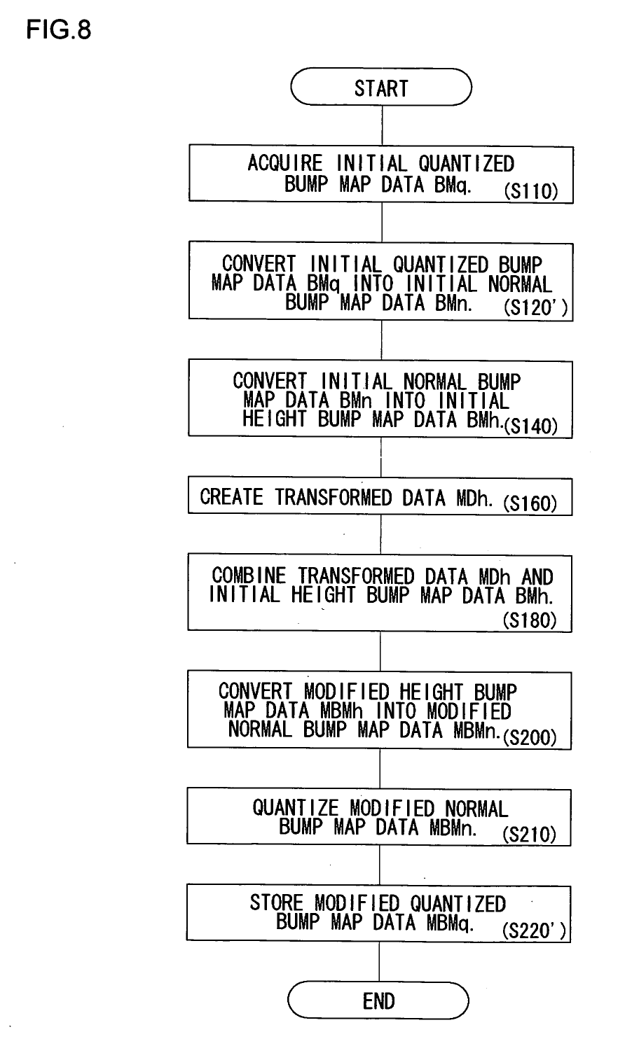

FIG. 8 is a flowchart showing a method for creating bump map data according to the second embodiment. Now, a description will be given not to the commonality but mainly to the difference between the method for creating bump map data according to the second embodiment and that according to the first embodiment.

First, the process acquires initial quantized bump map data BMq which represents the normal data of an untransformed object (S110). The initial quantized bump map data BMq has the normal vectors which are quantized and described by the index ID.

Next, referring to the VQ table that relates the index ID to the reference normal vector Vqn, the process de-quantizes the initial quantized bump map data BMq to acquire the initial normal bump map data BMn described by normal vectors (S120′).

Next, following the same procedure as in the first embodiment (from S140 to S200), the process creates the modified normal bump map data MBMn.

In the second embodiment, the process then quantizes the normal vectors describing the modified normal bump map data MBMn, thereby creating modified quantized bump map data MBMq for storage (S210 and S220′). In this quantization, each normal vector describing the modified normal bump map data MBMn is replaced with the most successfully approximating one of the reference normal vectors Vqn to be described by its index ID.

Through the aforementioned procedure, it is possible to create the modified quantized bump map data MBMq which has normal vectors described by 8-bit index ID.

A transformed object 10′ having roughness represented by the modified quantized bump map data MBMq thus created can be shaded as follows.

As described above, brightness values a are pre-calculated for the plurality of reference normal vectors and stored in the CLUT. Accordingly, referring to the CLUT in accordance with the index ID of the normal vector of each pixel, the process acquires the brightness value α associated with the index ID. Using the brightness value α, the process performs blending to correct the color of each pixel, thereby making it possible to represent the roughness of the object.

After the modified quantized bump map data MBMq has been created through the series of transformations described above, the process returns to the processing in S110, where the process repeats the same processing using the modified quantized bump map data MBMq as the initial quantized bump map data BMq, thereby making it possible to create high-speed animations.

According to the method for creating bump map data and the graphic processing method in accordance with this embodiment, the bump map data is described by quantized reference normal vectors, and the brightness value α is pre-calculated for each reference normal vector. This eliminates the need for calculating the brightness value of each pixel each time a transformation is carried out, thereby making it possible to perform graphic processing at high speeds.

Furthermore, since the bump map data is retained in the form of the index, it is possible to save memory spaces.

Now, a description is given to a graphic processing apparatus 100 for implementing graphic processing according to this embodiment.

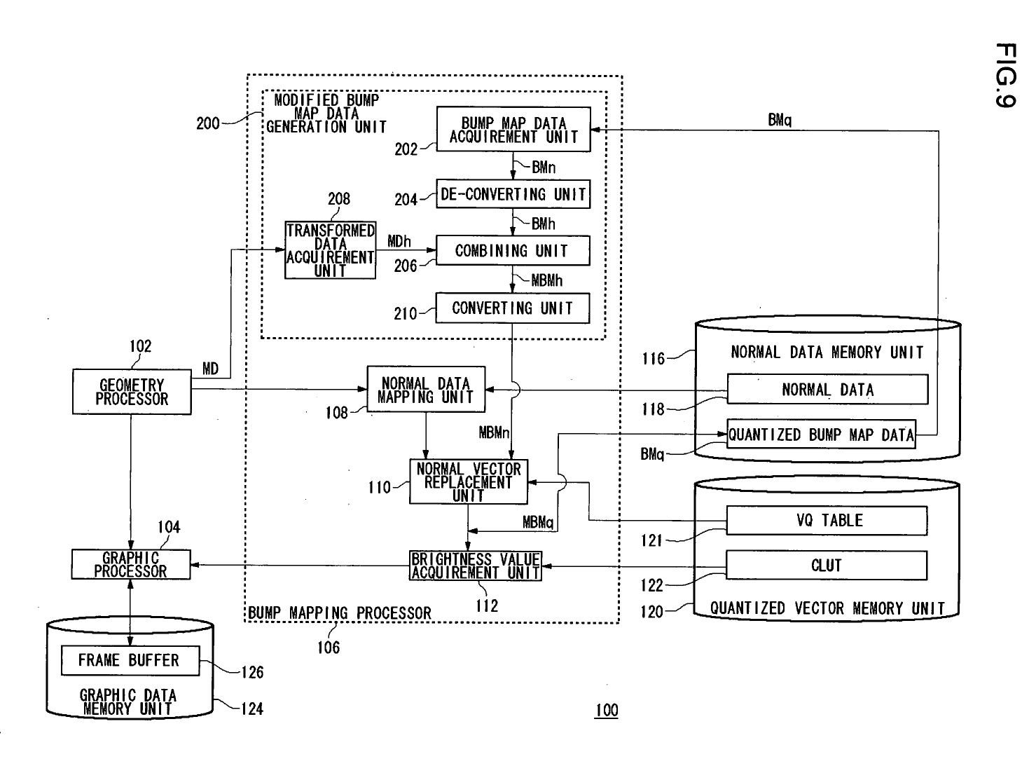

FIG. 9 is a view illustrating the configuration of the graphic processing apparatus 100 according to the second embodiment. The graphic processing apparatus 100 creates graphic data for displaying the model information of a 3D object on a display device, and as required, performs bump mapping to map pseudo roughness to the surface of the 3D object. This bump mapping allows the transformation applied to the object shape described in the first and second embodiments to be represented in a pseudo manner.

A geometry processor 102 performs geometry processing on the 3D object to create a display list that contains polygon definition information such as on the shape of a polygon and its position in coordinates, and the LOD (Level of Detail) value that indicates the level of detail in drawing a polygon. A polygon to be bump mapped is provided with data indicative of the polygon being bump mapped. Whether the bump mapping is performed may be pre-determined at the time of modeling of the object or dynamically determined at the time of graphic processing.

A bump mapping processor 106 receives the display list from the geometry processor 102 and then creates normal data 118 for defining pseudo roughness on the polygon surface, followed by bump mapping being performed on the polygon being bump mapped. The bump mapping processor 106 according to this embodiment utilizes a “quantized bump mapping” technique, in which a pseudo-normal vector created on the surface of a polygon is vectorially quantized to be thereby replaced by a reference normal vector, so that brightness calculations are performed only on the reference normal vector.

A graphic processor 104 writes or reads graphic data on a frame buffer 126 that is provided in a graphic data memory unit 124. The graphic processor 104 maps a texture to a polygon surface to determine the RGB value of each pixel on the polygon surface. For the polygon that is bump mapped by the bump mapping processor 106, the graphic processor 104 blends the resulting RGB value with the brightness value a acquired by the bump mapping processor 106 for shading, and then determines a final RGB value, which is in turn written on the frame buffer 126.

The image data drawn on the frame buffer 126 in this manner is converted into video output to be supplied to the display device, thus displaying an image of the object that is provided with a pseudo representation of roughness on the surface through bump mapping.

Now, the configuration of the bump mapping processor 106 is detailed below.

The bump mapping processor 106 includes a normal data mapping unit 108, a normal vector replacement unit 110, a brightness value acquirement unit 112, and a modified bump map data generation unit 200.

Based on the display list created by the geometry processor 102, the normal data mapping unit 108 identifies a polygon to be bump mapped, and then maps thereto the normal data 118 in order to define pseudo roughness on the surface of the identified polygon. The normal data 118 is indicative of normal vectors that have not yet been mapped to the object, as shown in FIG. 5B.

The normal data 118, which defines pseudo roughness on a polygon surface, is stored in a normal data memory unit 116 in the form of texture. As the normal data 118, color data of each pixel is stored for use in typical texture mapping, but as used herein, the normal vector value of each pixel is stored to be used as bump map data.

The normal data mapping unit 108 reads the normal data 118 on the normal data memory unit 116 to affix the normal data 118 to the polygon surface according to a typical texture mapping method. This allows for providing a variation caused by bump mapping to the normal vector indicative of the original normal direction to the polygon surface, thereby creating the bump map data BMn as shown in FIG. 5C.

The normal vector replacement unit 110 performs a vector quantization on the normal vector describing the bump map data BMn created by the normal data mapping unit 108 to substitute the resulting normal vector into the reference normal vector Vqn. The vector quantization is performed such that a predetermined quantity of reference normal vectors Vqn is pre-specified as a representative vector for a given pseudo-normal vector that can be defined on the surface of a 3D object, and then the given pseudo-normal vector is approximated by one of the reference normal vectors Vqn that is closest thereto.

Combinations of the reference normal vectors are stored in a quantized vector memory unit 120 in the form of a VQ table 121. The VQ table 121 associates the reference normal vector Vqn shown in FIG. 7 with its index ID.

Referring to the VQ table 121, the normal vector replacement unit 110 converts the pseudo-normal vector created on the polygon surface into the reference normal vector that is closest to the pseudo-normal vector to acquire the index ID thereof.

The resulting quantized bump map data BMq is stored in the normal data memory unit 116 as required.

The quantized vector memory unit 120 stores a CLUT 122 in which stored is the brightness value a associated with the index of the reference normal vector in the VQ table 121. Suppose that the reference normal vector in the VQ table 121 is in the normal direction of the object surface. In this case, the brightness value of the surface can be calculated by assuming a type and location of the light source for shading.

In accordance with the index ID acquired by the normal vector replacement unit 110, the brightness value acquirement unit 112 refers to the CLUT 122 to acquire the brightness value α associated with the reference normal vector. The brightness value acquirement unit 112 provides data on the brightness value α of the polygon surface determined through bump mapping to the graphic processor 104.

The modified bump map data generation unit 200 creates the modified normal bump map data MBMn that is used in applying a transformation to an object being drawn.

The modified bump map data generation unit 200 includes a bump map data acquirement unit 202, a de-converting unit 204, a combining unit 206, a transformed data acquirement unit 208, and a converting unit 210.

The bump map data acquirement unit 202 acquires, from the normal data memory unit 116, the quantized bump map data BMq that is mapped to an untransformed object. Since the quantized bump map data BMq is described by the index ID, the bump map data acquirement unit 202 refers to the VQ table 121 to convert the index into a normal vector to acquire the initial normal bump map data BMn.

The de-converting unit 204 inversely converts the initial normal bump map data BMn in the form of normal data into the initial height bump map data BMh in the form of height data.

The transformed data acquirement unit 208 receives data indicative of the contents of a transformation to the object to be delivered from the geometry processor 102, and then creates the transformed height data MDh that is associated with the contents of the transformation described in the form of height data.

The combining unit 206 combines the initial height bump map data BMh delivered from the de-converting unit 204 and the transformed height data MDh delivered from the transformed data acquirement unit 208 to create the modified height bump map data MBMh for output to the converting unit 210.

The converting unit 210 delivers, to the normal vector replacement unit 110, the modified normal bump map data MBMn in the form of normal data into which converted is the modified height bump map data MBMh in the form of height data.

The normal vector replacement unit 110 quantizes the modified normal bump map data MBMn for conversion into the modified quantized bump map data MBMq. The modified quantized bump map data MBMq is written onto the normal data memory unit 116 and delivered to the brightness value acquirement unit 112.

Now, a description will be given to the operation of the graphic processing apparatus 100 configured as described above.

Suppose that on the frame buffer, the graphic processing apparatus 100 draws the object 10, shown in FIG. 1A, whose shallow roughness 12 is represented by bump map data in a pseudo manner. Under this situation, the description will be given to a series of processing to be performed when the object 10 is transformed by adding new roughness 14 thereto to draw the object 10′ shown in FIG. 1B.

The bump map data used to represent this transformation is created as follows by means of the modified bump map data generation unit 200.

The normal data used to draw the untransformed object 10 is quantized and kept unchanged as the quantized bump map data BMq in the normal data memory unit 116. The bump map data acquirement unit 202 acquires the quantized bump map data BMq as the initial quantized bump map data for conversion into the initial normal bump map data BMn in the form of normal data.

The de-converting unit 204 converts the initial normal bump map data BMn into the initial height bump map data BMh in the form of height data.

The transformed data acquirement unit 208 of the modified bump map data generation unit 200 is supplied, from the geometry processor 102, with the data corresponding to the contents of the transformation applied to the object 10, i.e., the transformed data MD describing the new roughness 14.

The transformed data MD is converted by the transformed data acquirement unit 208 into the transformed height data MDh in the form of height data for output to the combining unit 206. The combining unit 206 combines the initial height bump map data BMh and the transformed height data MDh to create the modified height bump map data MBMh. The modified height bump map data MBMh is converted by the converting unit 210 into the modified normal bump map data MBMn in the form of normal data.

In this manner, the modified normal bump map data MBMn created by the modified bump map data generation unit 200 is supplied to the normal vector replacement unit 110. The normal vector replacement unit 110 quantizes the modified normal bump map data MBMn for conversion into the modified quantized bump map data MBMq. The brightness value acquirement unit 112 refers to the CLUT 122 to acquire the brightness value α of each pixel from the modified quantized bump map data MBMq for output to the graphic processor 104. The graphic processor 104 blends the brightness values a thus acquired for shading to determine the final RGB value, which is in turn written onto the frame buffer 126.

The graphic processing apparatus 100 represents a transformation applied to an object in a pseudo manner using the modified bump map data that is created by the modified bump map data generation unit 200. It is thus possible to perform graphic processing at higher speeds when compared with the case where the shape of the object itself is modified at the level of the polygon to perform bump mapping again.

### THIRD EMBODIMENT

In the first and second embodiments, a transformation was carried out in the form of height data, which was then converted back to the form of normal data to thereby create bump map data. However, in the third embodiment to be described below, the transformation is carry out in the form of normal data.

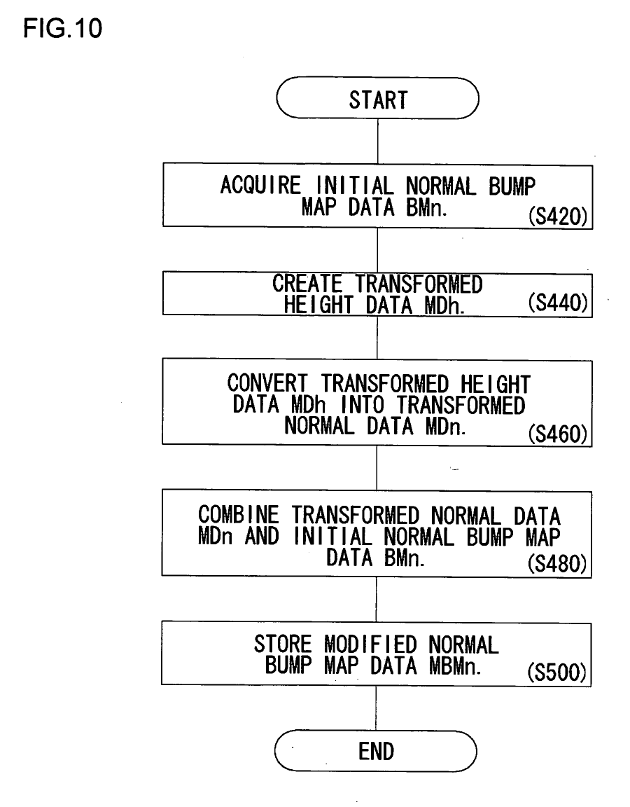

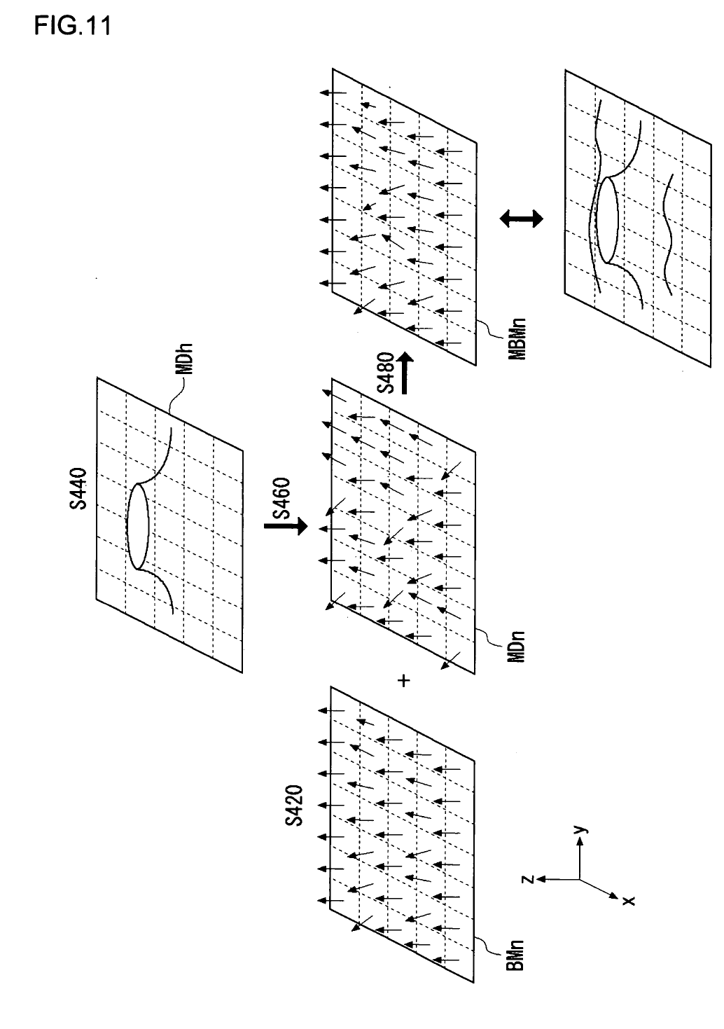

FIG. 10 is a flowchart showing a method for creating bump map data according to the third embodiment. FIG. 11 is a view schematically illustrating the method for creating bump map data according to the third embodiment. In FIGS. 10 and 11, the same reference symbols are given to those steps that are associated with each other.

In the method for creating bump map data according to this embodiment, the process first acquires the initial normal bump map data BMn that is the normal data of the untransformed object 10 (S420).

Next, the process creates the transformed height data MDh that is associated with the shape to be added to the object 10 (S440). The transformed height data MDh is described by height data.

Next, the process converts the transformed height data MDh into transformed normal data MDn in the form of normal data (S460). As described above, this conversion step can be carried out by performing a spatial partial differentiation on height data. The aforementioned processing in step S420 may be performed after the processing in step S460.

Next, the process combines the transformed normal data MDn and the aforementioned initial normal bump map data BMn (S480).

The combining process performed in S480 can be carried out by calculating a vector sum. In this combining process, a combination may be provided by weighting the initial normal bump map data BMn and the transformed normal data MDn using factors m and n. The modified normal bump map data MBMn resulting from the weighted combination is given by MBMn=m×MDn+n×BMn.

The weighting factors m and n may be a constant or a variable of coordinates (x, y). Suppose that the factors m and n are a function of coordinates (x, y). In this case, for example, in applying a transformation to the object 10, it is possible to assign an increased weight n to the transformed normal data MDn for the region that will have a distinctive transformed shape.

The weighting factor may also be determined based on the value of the transformed height data MDh. For example, the transformed height data MDh can be used to emphasize the roughness of a transformed object by assigning an increased weight n to a region having a higher altitude.

The modified normal bump map data MBMn resulting from such a combining process represents the normal direction of the surface shape of the transformed object 10′.

Finally, the modified normal bump map data MBMn is stored to shade the object 10′ (S500).

As in the first embodiment, in shading and drawing the transformed object 10′, the modified normal bump map data MBMn can be used to calculate the brightness value α of each pixel, thereby representing the roughness of the object 10′.

The method for creating bump map data according to this embodiment applies a transformation to the object 10 not by changing the shape of the object 10 itself but by carrying out a transformation in the region of bump map data. This allows for reducing the amount of calculations and thereby realizing transformations at high speeds.

Furthermore, the method for creating bump map data according to this embodiment combines vectorially the untransformed normal data BMn and the normal data MDn indicative of the contents of a transformation. This allows the bump map data resulting from the combining process is to be described by normal data. As a result, when compared to the first embodiment, this embodiment can reduce the number of conversions between height data and normal data.

### FOURTH EMBODIMENT

As in the second embodiment, a method for creating bump map data according to the fourth embodiment quantizes the normal vector describing a normal bump map, thereby performing graphic processing at high speeds. To this end, as in the second embodiment, reference normal vectors are pre-specified to calculate the brightness value α for each reference normal vector for storage in the CLUT.

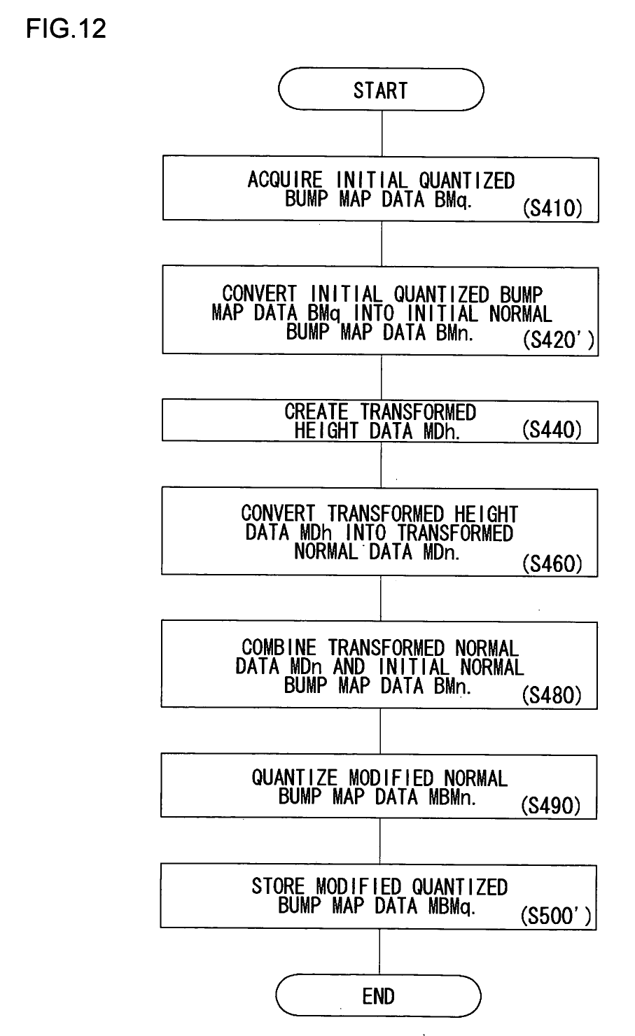

FIG. 12 is a flowchart showing the method for creating bump map data according to the fourth embodiment. Now, a description will be given mainly to the difference between the method for creating bump map data according to the third embodiment and that according to the fourth embodiment.

First, the process acquires the initial quantized bump map data BMq (S410). The initial quantized bump map data BMq has normal vectors which are quantized and described by the index ID.

Next, referring to the VQ table that associates the index ID with the reference normal vector, the process acquires the initial normal bump map data BMn described by normal vectors (S420′).

Next, as in the third embodiment, the process performs the processing from S440 to S480 to create the modified normal bump map data MBMn.

Next, the process converts the modified normal bump map data MBMn into the modified quantized bump map data MBMq (S490) for storage (S500′). Here, the normal vector of each pixel is quantized into one of the reference normal vectors that most closely approximates the normal vector, and the modified quantized bump map data MBMq is described by the index ID of the reference normal vector.

The aforementioned procedure makes it possible to create the modified quantized bump map data MBMq having normal data described by the index.

The processing from S420′ to S490 in the method for creating bump map data according to the fourth embodiment shown in FIG. 12 can also be performed as follows.

First, the process prepares an operation table which contains pre-calculated sums of vectors for all the combinations of the quantized reference normal vectors Vqn. The normal vector resulting from the vector combination is quantized and substituted into the reference normal vector, and then stored as its index in the operation table. For example, when the normal vector is quantized using eight bits, there are 256 times 256 possible combinations of vector sums, and a combined vector is calculated for each combination.

Skipping the processing in S420′, the process may create the transformed height data MDh (S440) for conversion into the transformed normal data MDn (S460), and then quantize the transformed normal data MDn to create transformed quantized data MDq (S460′).

Then, the process combines the transformed quantized data MDq and the initial quantized bump map data BMq (S480′). This combining process can be performed referring to the aforementioned operation table. The result obtained from the combining process turns to be the modified quantized bump map data MBMq (S500′).

In this manner, an operation table of vector combinations may be created in advance for quantized reference normal vectors. This eliminates the need for converting the quantized data into the form of normal data for re-quantization, whereby the computation can be performed at increased speeds.

The process performs graphic processing as follows in accordance with the modified quantized bump map data MBMq created through the flowchart shown in FIG. 12.

The brightness values α are pre-calculated for a plurality of reference normal vectors and stored in the CLUT. Accordingly, the shading of the object 10′ whose roughness is represented by the modified quantized bump map data MBMq thus created can be carried out as follows. That is, the process acquires the index of the normal vector of each pixel, and then referring to the color lookup table CLUT, acquires the brightness value α corresponding to the normal vector, followed by correcting the color of each pixel using the brightness value α.

After the modified quantized bump map data MBMq has been created through the aforementioned series of transformations, the process returns to the processing in S410, where the process repeats the same processing using the modified quantized bump map data MBMq as the initial quantized bump map data BMq, thereby making it possible to create high-speed animations.

The graphic processing according to this embodiment can be implemented by modifying the configuration of the modified bump map data generation unit 200 of the graphic processing apparatus 100 shown in FIG. 9.

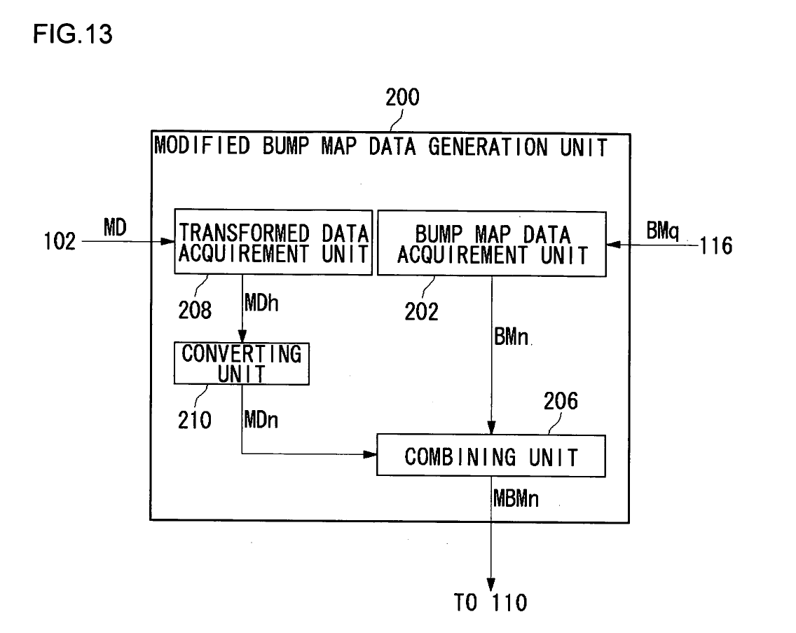

FIG. 13 is a view illustrating the configuration of a modified bump map data generation unit 200′ for implementing a graphic processing method according to the embodiment.

The modified bump map data generation unit 200′ includes the bump map data acquirement unit 202, the transformed data acquirement unit 208, the converting unit 210, and the combining unit 206.

The bump map data acquirement unit 202 acquires, from the normal data memory unit 116, the quantized bump map data BMq that is mapped to an untransformed object. The bump map data acquirement unit 202 refers to the VQ table 121 to convert the index into the form of a normal vector to acquire the initial normal bump map data BMn.

The transformed data acquirement unit 208 receives the transformed data MD indicative of the contents of a transformation applied to the object to be delivered from the geometry processor 102, and then creates the transformed height data MDh that is described in the form of height data and associated with the contents of the transformation.

The converting unit 210 converts the transformed height data MDh described by height data into the transformed normal data MDn in the form of normal data.

The combining unit 206 combines the initial normal bump map data BMh delivered from the bump map data acquirement unit 202 and the transformed normal data MDn delivered from the converting unit 210 to create the modified normal bump map data MBMn for output to the normal vector replacement unit 110.

The normal vector replacement unit 110 quantizes the modified normal bump map data MBMn for conversion into the modified quantized bump map data MBMq. The modified quantized bump map data MBMq is written onto the normal data memory unit 116 and delivered to the brightness value acquirement unit 112.

According to the method for creating bump map data, the graphic processing method, and the graphic processing apparatus 100 in accordance with this embodiment, the reference normal vectors having quantized normal data are allowed to describe bump map data, and the brightness value α is pre-calculated for each reference normal vector. This eliminates the need for calculating the brightness value of each pixel every time a transformation is carried out, thereby making it possible to perform graphic processing at high speeds.

In the foregoing, the present invention has been described in accordance with the embodiments. It will be understood by those skilled in the art that the embodiments were only illustrative, and various modifications may be made to the combinations of each component and each process without departing from the scope of the invention.

In the aforementioned embodiment, such a case has been described where a transformation was applied to the bump map data BMn, shown in FIG. 5C, which is obtained by mapping normal data to an object, and a computation is performed on a per-object basis. However, the present invention is not limited to that case.

For example, as shown in FIG. 5B, a transformation may also be applied, using the bump map creating method described in relation to the embodiment, to the normal data Mv that has not yet been mapped to the object. The resulting bump map data may be mapped to the object, thereby creating the transformed bump map data.

In this case, the bump map data is to be created and the mapping is then performed not on a per-object basis, as described in relation to the embodiment, but on a per-polygon-surface basis.

In the aforementioned embodiment, combinations of reference normal vectors were prepared which indicated the respective normal directions of divided planes obtained by dividing a spherical surface into 256 planes. The brightness values for the combinations of the reference normal vectors were pre-calculated and stored in the CLUT. However, the reference normal vector may also be dynamically created in bump mapping. That is, each time a bump map is mapped to the polygon surface to determine a pseudo-normal vector, the pseudo-normal vector may be quantized to determine the reference normal vector, then allowing the brightness for the reference normal vector to be calculated and stored in the CLUT. This may require an additional time for the quantization and calculation of the brightness of each polygon, but makes it possible to perform optimized processing on each polygon, thereby providing improved image quality.

Furthermore, in the aforementioned embodiment, assuming that there would be no change in the type or location of the light source, the CLUT having pre-calculated brightness values was used to acquire the brightness value. However, in the presence of any change in the type or location of the light source, the brightness can be re-calculated as required to update the CLUT.

The quantity of reference normal vectors can be designed at the time of modeling an object depending on the accuracy required for the quantized bump mapping or the requirements for the final image quality. In general, the quantity of reference normal vectors is determined depending on the trade-off between the amount of calculations and the image quality. On the other hand, to accommodate changes in requirements for the image quality as circumstances demand, the quantity of reference normal vectors may be dynamically changed. Alternatively, the quantity of reference normal vectors may also be changed depending on the LOD value. For example, as the LOD for graphic processing of a polygon increases, the quantity of reference normal vectors can be increased, thereby adjusting the accuracy of bump mapping.

While the preferred embodiments of the present invention have been described using specific terms, such description is for illustrative purposes only, and it is to be understood that changes and variations may be made without departing from the spirit or scope of the appended claims.

What is claimed is:

1. A method for creating normal map data, comprising:
firstly converting normal map data described by a normal vector into height map data described in the form of height data;
combining transformed height data describing contents of a transformation in the form of height data with the height map data to create modified height map data;
converting the modified height map data into modified normal map data described by a normal vector; and
storing the modified normal map data.

2. A method for creating normal map data, comprising:
firstly converting normal map data described by a normal vector into height map data described in the form of height data;
creating modified height map data by modifying the height data describing the height map data thus obtained, corresponding to contents of a transformation;
converting the modified height map data into modified normal map data described by a normal vector; and
storing the modified normal map data.

3. The method for creating normal map data according to claim 1, wherein:
the normal vector describing the normal map data used in the first conversion is quantized; and
the storing is performed such that the normal vector describing the modified normal map data is also quantized.

4. The method for creating normal map data according to claim 2, wherein:
the normal vector describing the normal map data used in the first conversion is quantized; and
the storing is performed such that the normal vector describing the modified normal map data is also quantized.

5. A graphic processing method comprising:
previously calculating a brightness value for each quantized normal vector; and
when shading is performed based on the modified normal map data created by the method for creating normal map data according to claim 3, referring to a brightness value corresponding to the quantized normal vector describing the modified normal map data, and performing shading based on the referred brightness value.

6. A graphic processing method comprising:
previously calculating a brightness value for each quantized normal vector; and
when shading is performed based on the modified normal map data created by the method for creating normal map data according to claim 4, referring to a brightness value corresponding to the quantized normal vector describing the modified normal map data, and performing shading based on the referred brightness value.

7. A method for creating normal map data comprising:
converting transformed height data describing contents of a transformation in the form of height data into transformed normal data described by a normal vector;
combining the transformed normal data with normal map data described by a normal vector to create modified normal map data; and
storing the modified normal map data.

8. The method for creating normal map data according to claim 7, wherein the combining is performed such that the transformed normal data and the normal map data are weighted for addition.

9. The method for creating normal map data according to claim 8, wherein
the combining is performed such that, for a region having a distinctive shape indicated by the transformed height data, the transformed normal data obtained through a conversion of the transformed height data is assigned a heavier weight.

10. The method for creating normal map data according to claim 7, wherein:
the normal vector describing the normal map data is quantized; and
the storing is performed such that the normal vector describing the modified normal map data is also quantized.

11. A graphic processing method comprising:
previously calculating a brightness value for each quantized normal vector; and
when shading is performed based on the modified normal map data created by the method for creating normal map data according to claim 10, referring to a brightness value corresponding to the quantized normal vector describing the modified normal map data, and performing shading based on the referred brightness value.

12. A graphic processing apparatus comprising:
a de-converting unit which converts normal map data described by a normal vector into height map data described in the form of height data once;
a combining unit which combines transformed height data describing contents of a transformation in the form of height data with the height map data to create modified height map data;
a converting unit which converts the modified height map data into modified normal map data described by a normal vector; and
a memory which stores the modified normal map data.

13. A graphic processing apparatus comprising:
a converting unit which converts transformed height data describing contents of a transformation in the form of height data into transformed normal data described by a normal vector;
a combining unit which combines transformed normal data with normal map data described by a normal vector, to create modified normal map data; and
a memory which stores the modified normal map data.

14. A program making a computer execute:
firstly converting normal map data described by a normal vector into height map data described in the form of height data;
combining transformed height data describing contents of a transformation in the form of height data with the height map data to create modified height map data;
converting the modified height map data into modified normal map data described by a normal vector; and
storing the modified normal map data.

15. A program making a computer execute:
firstly converting normal map data described by a normal vector into height map data described in the form of height data;
modifying height data describing the height map data thus obtained, corresponding to contents of a transformation, to create modified height map data;
converting the modified height map data into modified normal map data described by a normal vector; and
storing the modified normal map data.

16. A program making a computer execute:
converting transformed height data describing contents of a transformation in the form of height data into transformed normal data described by a normal vector;
combining the transformed normal data with normal map data described by a normal vector to create modified normal map data; and
storing the modified normal map data.
